(19) United States
(12) Patent Application Publication
(10) Pub. No.: US 2010/0307877 A1
(43) Pub. Date: Dec. 9, 2010

(54) ACTIVE VIBRATION-EXTINGUISHER CONTAINING MAGNETO- OR ELECTRORHEOLOGICAL FLUIDS, METHOD FOR REDUCING VIBRATIONS AND USES THEREOF

(75) Inventors: Holger Bose, Wurzburg (DE); Thomas Gerlach, Schweinfurt (DE); Johannes Ehrlich, Wiesenbronn (DE); Angelo Merlo, Novara (IT); Ippolito Massimo, Asti (IT)

Correspondence Address: BARNES & THORNBURG LLP, 11 SOUTH MERIDIAN, INDIANAPOLIS, IN, 46204, US

(73) Assignee: Fraunhofer-Gesellschaft zur forderung der Angewandten Forschung e.V, Munchen (DE)

(21) Appl. No.: 12/395,770

(22) Filed: Mar. 2, 2009

(30) Foreign Application Priority Data
Mar. 6, 2008 (EP) 08 004 199.9

(51) Int. Cl. F16F 15/03; F16F 7/00; F16F 9/53; F16F 7/10

(52) U.S. Cl. 188/378; 188/267.2; 188/267.1

(57) ABSTRACT

Present invention relates to a device for reducing vibrations of a vibrating object as well as a method for reducing vibrations, wherein the perturbing vibrations are reduced drastically by induction of counter-forces. In general, vibrations of equal frequency (counter-vibration) as the perturbing vibration are generated. The force generated by the counter-vibration acts onto the vibrating object, whose amplitude of vibration is to be reduced. The phasing of the counter-vibration is antipodal to the vibration to be reduced, preferably the force of the generated counter-vibration is greater than the force being necessary for compensation of the perturbing vibration. The transfer of the force of the counter-vibration onto the vibrating object is affected by means of a magnetorheological or electrorheological material, whereby the absolute value of the transmitted force is adjusted by the magnitude of an applied magnetical or electric field. With increasing strength of the magnetical or electric field, the magnetorheological or electrorheological material is stiffened increasingly. With optimal adjustments of the strength of the electric or magnetic field, the transmitted force equals the perturbing force and the perturbing vibration is compensated.

Present invention relates to a device for reducing vibrations of a vibrating object as well as a method for reducing vibrations, wherein the perturbing vibrations are reduced drastically by induction of counter-forces. In general, vibrations of equal frequency (counter-vibration) as the perturbing vibration are generated. The force generated by the counter-vibration acts onto the vibrating object, whose amplitude of vibration is to be reduced. The phasing of the counter-vibration is antipodal to the vibration to be reduced, preferably the force of the generated counter-vibration is greater than the force being necessary for compensation of the perturbing vibration. The transfer of the force of the counter-vibration onto the vibrating object is affected by means of a magnetorheological or electrorheological material, whereby the absolute value of the transmitted force is adjusted by the magnitude of an applied magnetical or electric field. With increasing strength of the magnetical or electric field, the magnetorheological or electrorheological material is stiffened increasingly. With optimal adjustments of the strength of the electric or magnetic field, the transmitted force equals the perturbing force and the perturbing vibration is compensated.

Magnetorheological materials, especially fluids, are suspensions of magnetically polarizable particles in a carrier substance, especially a carrier liquid, whose modulus of rigidity, shear modulus, Young's modulus and/or the yield stress can be changed in an electric or magnetic field quickly and reversibly. In analogy, electrorheological materials, especially electrorheological fluids, are suspensions of electrically polarizable particles in a non-conducting carrier liquid, whose modulus of rigidity, the shear modulus, the Young's modulus and/or the yield stress can be changed quickly and reversibly in an electric field. Both classes of materials therefore offer an ideal basis for an adaptive force-transfer wherein the force to be transferred is controlled via the external field.

Devices for reducing vibrations in which the force for reduction of the vibration is generated by a magnetorheological or electrorheological fluid in a magnetic or an electric field, respectively, are already known. The advantage of such devices is the short reaction time towards a change in field intensity. For example, magnetorheological devices for reducing vibrations are known from the EP 1 270 988 B1 and DE 101 43 980 A1.

However, the devices for reducing vibrations known from the prior art are adaptive damping-systems on basis of magnetorheological or electrorheological fluids, in which the damping-force can be controlled by the magnetic or electric field intensity, respectively. The disadvantage of these systems is that only passive forces can be generated.

It is therefore an object of present invention to provide a system for reducing vibrations, which allows providing active forces for reducing vibrations of a vibrating object. Furthermore, it is an object of present invention to provide a method for reducing vibrations for a vibrating object, wherein the method guarantees an effective reducing of vibrations.

These objects are accomplished by the features of the independent claims. The further dependent claims describe advantageous embodiments.

According to the invention, there is provided a device for reducing vibrations of a vibrating object, wherein the device comprises:
a) at least one actively controllable unit for generating a temporarily varying force,
b) at least one force transmitting unit which comprises at least one segment which contains at least one electrorheological and/or magnetorheological material,
c) at least one unit for generating an electric and/or magnetic field,
   wherein the device is connected by force to the at least one force transmitting unit.

In contrast to the devices described in prior art, the device for reducing vibrations according to the invention transfers an externally generated force via a magnetorheological or electrorheological material in order to meet individual needs for reducing troublesome vibrations by inducing an actively generated counter-force. The magnetorheological or electrorheological material thereby acts as a coupling-medium, the consistence of which can be controlled via a magnetic or electric field.

Therefore, it is preferred if the at least one actively controllable unit is at least one device for generating a force that varies in one, two and/or three dimensions. Especially, the at least one actively controllable unit comprises at least one motor, preferably a motor selected from the group consisting of electric motors, combustion motors, electromagnetic actuators, voice coils and/or other actuators. In such, the actively controllable unit is not limited as far as it is assured that the device allows a generation of a varying force. In a further embodiment, two or more devices are present for generating the varying force.

In an especially preferred embodiment, the motor is connected by force to an excentric for conversion of a circular motion into stroke movement, in such that the excentric can be agitated by the motor.

A further advantageous embodiment provides that the at least one force transmitting unit comprises two elements which are movable with respect to each other, border the force transmitting unit and enclose the at least one segment, wherein the elements preferably are aligned parallelly. These elements preferably exhibit two surfaces, which are parallel aligned. In such, the shape of the two elements is not limited in any respect, yet it is preferred, if the two elements are selected from the group consisting of plates, cuboids, segments, ovoid shaped elements, spherical shells and/or cones, wherein parallel plates are especially preferred.

Moreover, it is advantageous, if the two elements are movable in one, two and/or three dimensions with respect to each other. In such, the device is separated into two sections which are movable with respect to each other, wherein these two sections are bordered by the two elements.

Herein, it is preferred, if one element is connected by force with the at least one device for generating the varying force, whereas the other element is connectable by force to the vibrating object. This embodiment enables a direct force transmittal between the at least one actively controllable unit and the vibrating object.

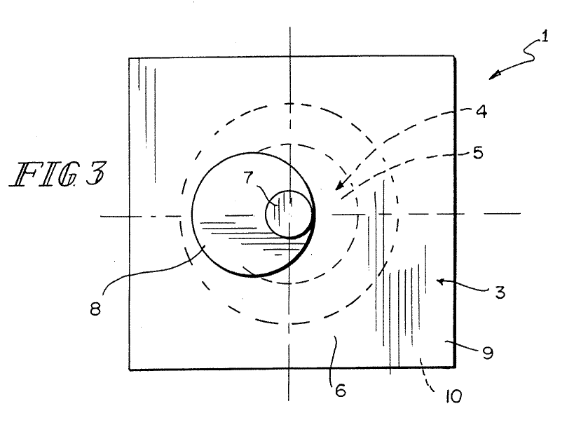

Furthermore, it is a special embodiment of present invention that the segment has a cross-sectional area which is dimensioned smaller than the cross-sectional area of the elements. In this embodiment, in projection onto the cross-sectional area of the segment, the elements are larger and overlap the segment (see also FIG. 3 and description).

It is especially preferred, if the at least one unit for generating a magnetic or electric field is at least partially located within the at least one force transmitting unit. It is hereby understood that the unit for generating the field can be composed of any of the parts of the force transmitting unit, e.g. the elements. Alternatively, the unit can be composed of additional parts, which are at least partially located inside the force transmitting unit. Those embodiments guarantee an extremely compact assembly of the device.

A further advantageous embodiment provides that the unit for generating an electric and/or magnetic field is located in direct proximity to the segment, so that it is guaranteed that the segment is permeated by the electric and/or magnetic field. This feature is accomplished for example by aligning the unit around the segment, especially in a ring-like assembly like an electromagnetic coil or, alternatively, by a sandwich-like built-up, wherein the segment is aligned between the components for generating an electric and/or magnetic field like e.g. a pair of electrode plates.

Furthermore, it is preferred if at least one control system for controlling the actively controllable unit and/or at least one control system for controlling the at least one unit for generating a magnetic and/or electric field is comprised. This control system for example can comprise any electronic switching circuits or electronic guidance systems, which provide a direct response to the actively controllable unit and/or the unit for generating a field, thereby enabling an active control to the transmitted force from the actively controllable unit towards the vibrating object.

Preferably, the device comprises at least one sensor for registration of the amplitude, frequency and/or phase of the vibration of the vibrating object. This enables the device to be actively controlled dependent on the vibration of the vibrating object. The data derived from this sensor, e.g. the character of the vibration, can be used to generate a feedback and thus allows an active control of the controllable device and/or the unit for generating a magnetic and/or electric field. Therefore, it is especially preferred if the at least one control system for controlling the actively controllable unit and/or at least one control system for controlling the at least one unit for generating a magnetic and/or electric field is coupled to the at least one sensor.

According to one especially preferred magnetic embodiment of the invention, the unit for generating a magnetic field comprises at least one electromagnetic coil. The electromagnetic coil thereby is powered by at least one regulable electric power supply.

Preferably, the electromagnetic coil is located within the space between the two elements.

It is further advantageous if the at least one electromagnetic coil is ring-like and aligned concentrically around the at least one segment. This embodiment enables a strong injection of the generated magnetic field into the at least one segment and thereby into the magnetorheological material, since the electromagnetic coil and the segment are in direct vicinity with respect to each other.

Furthermore, it is preferred that the force transmitting unit, especially the two elements, comprises at least one ferromagnetic material in the magnetic circuit, which preferably is selected from the group consisting of iron, cobalt, nickel, ferromagnetic steel, alloys thereof and/or transformator sheets. This embodiment provides that any of the parts of the force transmitting unit can be made of a ferromagnetic material. According to the invention, transformator sheets are defined as laminated sheets, which are known to the person skilled in the art. The usage of transformator sheets, for example as materials for the two elements, avoids the generation of eddy currents.

It is especially preferred, that the magnetic circuit in the device (1) is at least partially built by a material that exhibits a relative permeability μᵣ>10, preferably >100, especially preferred >1000 and/or a saturation magnetisation of >0.5 T, preferably >1 T, especially preferred >1.5 T.

Furthermore, it is advantageous if at least one permanent magnet is included in the magnetic circuit. This feature concerns an embodiment of the invention, wherein for example the two elements are permanently magnetized so that a constant magnetic field is present. This constant magnetic field permanently affects the rheological properties of the magnetorheological material, being included in the segment. Thereby, the magnetorheological material exhibits a base rigidity, which further can be effected by superposing the permanent magnetic field with a varying magnetic field generated by the electromagnetic coil. Therefore, the special advantage of this embodiment is that less electric power is needed in order to modulate the rheological properties of the magnetorheological material in such that a certain rigidity or stiffness is reached.

The magnetorheological materials are not limited in any respect, yet it is preferred, if the material is selected from the group consisting of magnetorheological (MR) fluids, MR elastomeres, MR thermoplastic elastomeres, MR gels and/or MR foams.

In another especially preferred electric embodiment of present invention, the at least one unit for generating an electric field comprises two electrodes. In such, it is provided that any of the parts of the at least one unit for generating an electric field can be shaped as two electrodes, but alternatively, it is also possible that two separate electrodes are included in this unit. It is especially advantageous, if the electrodes are composed by the two elements. These two electrodes are powered by at least one regulable electric power supply. The electrodes are separated spatially, in such that it is guaranteed that high voltages can be applied to the electrodes but no electric breakdown occurs.

Again, the electrorheological materials are not limited in any way, but are preferably selected from the group consisting of electrorheological (ER) fluids, ER elastomeres, ER thermoplastic elastomeres, ER gels and/or ER foams.

Furthermore, present invention provides a method for reducing vibrations of a vibrating object, wherein a varying force is generated by at least one actively controllable unit and is transferred to the vibrating object via at least one electrorheological and/or magnetorheological material, characterized in that the varying force is adjusted by modulation of the at least one electrorheological and/or magnetorheological material, in such that the varying force counteracts at least partially the force resulting from the vibration of the vibrating object. It is a special advantage of the method according to the invention that relatively large forces for damping vibrations can be generated and transmitted to the vibrating object. The use of ER or MR materials opens a wide range of possible applications.

Preferably, the force being generated by the at least one actively controllable device is varied in its magnitude and/or in its direction, especially, the force is varied in one, two and/or three dimensions.

Over more, it is advantageous, if the at least one device generates the force with a frequency, which at least temporarily matches the frequency of the vibration of the vibrating object, wherein it is further preferred that the phase of the generated force is at least temporarily and/or partially antipodal to the phase of the vibration of the vibrating object. By this feature, perturbing vibrations of the object can be reduced to virtually zero.

E.g. the varying force can be generated by two or more units. The combined use of more than one unit brings additional advantageous effects:
1) Two or more devices rotating at different frequencies compose and approximate an arbitrary exciting waveform, which according to Fourier can be expressed by series of simpler sinusoidal waves, i.e. a square wave can be composed by the fundamental frequency plus the 3rd harmonic running in a second “vibraspin”, i.e. the second device.
2) The use of two or more devices enables the geometrical focus to be chosen and varied by applying the full biaxial damping force, i.e. two “vibraspin” placed radially opposed around a spindle can be driven in order to focus the action exactly near the TCP (tool central point).

This embodiment can be achieved in that each of the at least two units (2) generates varying forces, which are superimposed thus resulting in the varying force, which is transferred to the vibrating object (1′). In such, these embodiments enable special variations of the resulting force in time and/or in space.

In another preferred embodiment of the method according to the invention, the varying force which is generated by the at least one actively controllable device results from the rotation of an excentric and/or the agitation of a motor, preferably a motor selected from the group consisting of electric motors, combustion motors, electromagnetic actuators and/or voice coils. This embodiment allows the generation of effectively large harmonic forces with very simple technical means.

Preferably, the excentric is actuated by a motor, preferably an electromotor.

For providing a good match of the generated force and the vibration of the vibrating object, it is preferred if the speed of the motor, especially of the electromotor is controlled as a function of the frequency of the vibration of the vibrating object so that the frequency of the unbalance generated by the rotation of the excentric at least temporarily, preferably virtually at any time, matches the frequency of the vibration of the vibrating object.

Herein, it is preferred, if the motor, especially the electromotor, is controlled in such that the phase of the unbalance generated by the rotation of the excentric at least temporarily and/or partially is antipodal to the phase of the vibration of the vibrating object, i.e. the generated force can be described as counterforce to the force which results from the vibration.

Advantageously, the magnitude of the resulting varying force at least temporarily is adjusted at least to the same magnitude or larger than the magnitude of the force resulting from the vibration of the vibrating object. This is achieved by adjusting the weight of the excenter, the rotation speed of the excenter and/or the stiffness or rigidity of the ER or MR material. The special conditions for the afore-mentioned parameters can easily be determined by the person skilled in the art and of course depend on the characteristics of the vibration and/or the vibrating object.

Furthermore, it is preferred, if the adjusting of the magnitude of the force is achieved by modulation of at least one rheological property, preferably the shear modulus and/or the compression modulus of the at least one electrorheological and/or magnetorheological material.

Especially, the at least one rheological property, e.g. the shear modulus, is controlled by application of an electric and/or magnetic field, depending on the nature of the material, i.e. ER or MR material.

It is possible that the field intensity of the electric and/or magnetic field is held constant, varied and/or a constant field is superposed with a varying field.

The method according to the invention preferably is carried out with a device described in the foregoing.

Possible uses of the device as well as the method according to the invention are provided with claims 43 and 44.

The present invention is described in more detail in the subsequent description and the figures. However, the following description is not to be understood to limit the present invention in any respect.

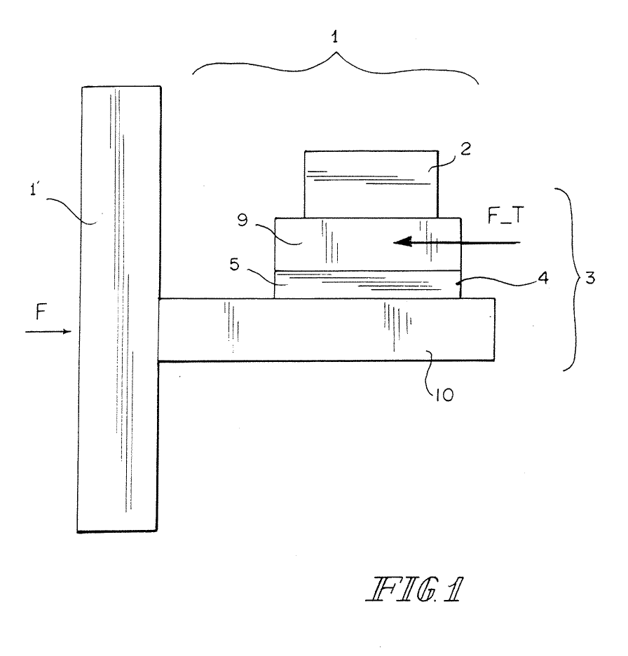

FIG. 1 shows a general assembly of a device 1 according to present invention, which is coupled to a vibrating object 1′.

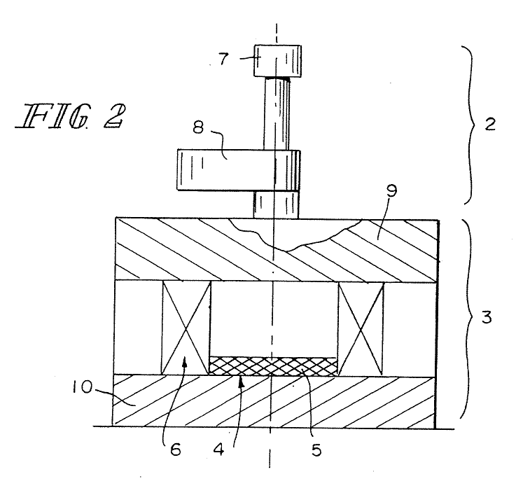

FIG. 2 shows a special embodiment of present invention, wherein the device 1 comprises a magnetic field generating unit, containing in this case an electromagnetic coil.

FIG. 3 depicts another perspective view (from above) of the device displayed in FIG. 2.

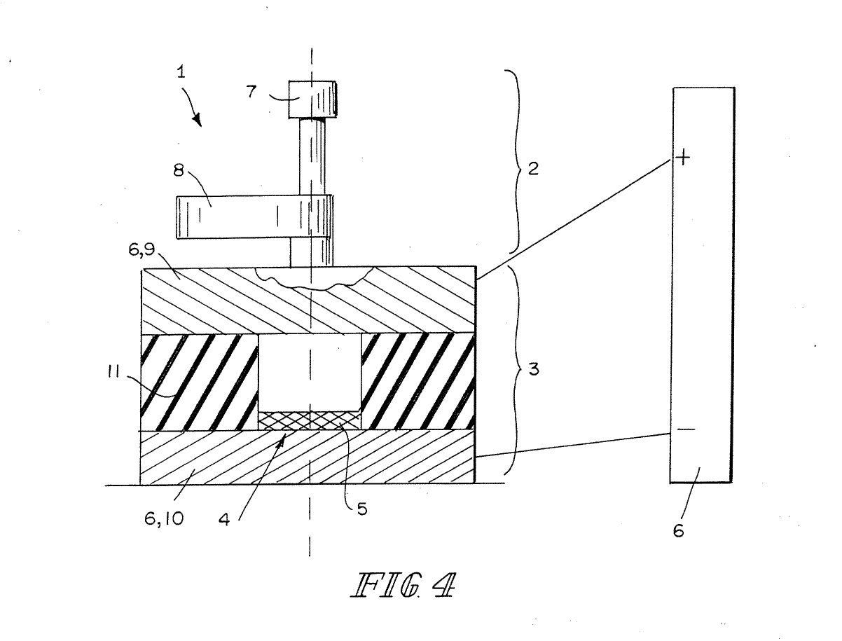

FIG. 4 describes the electric embodiment of the device 1, which comprises two electrodes for generating an electric field.

The generation and transmission of the counter-force generated by the extinction-oscillation (FIG. 1, F_T) onto the force, generated by the vibration to be extinguished (FIG. 1, F) is achieved according to the invention by the device 1, wherein a magnetorheological or an electrorheological material 5 in a segment 4 is comprised between two elements with parallelly aligned surfaces, which are movable relatively to each other. The magnetic or electric flux-lines run perpendicular to the surfaces. During the relative movement of the surfaces, the magnetorheological or electrorheological material is sheared (shear modulus). The strength of the mechanical coupling and thus the force to be transferred to the vibrating object 1′ can be adjusted by the magnetic or electric field strength, which is generated by the unit 6 (which in this case is composed by the plates 9, 10). Other possibilities of the transmittance of the force are the adjusting of the flow modulus, the squeeze modulus or mixed forms of movement of the named three modi together, depending on the nature of the ER or MR material to be used. Furthermore, one, two or three dimensional oscillations or vibrations can be generated by the device 2 and transferred via the magnetorheological or electrorheological material, which is included in the force transmitting unit 3.

A simple possibility to generate the counter-vibration is to use an electromotor, which drives a rotating mass with an unbalance (excenter). Thus, a relative small motor with small power consumption can generate relatively large forces (centrifugal forces). Because of the circular nature of the thus generated counter-vibration, also vibrations with amplitudes in two-dimensions can be compensated, these vibrations for example can occur during rotations of arbors of a machine or during stroke movements of lobes, pistons or plungers and the like.

The magnetic or electric field for stiffening the magnetorheological or electrorheological material usually is generated via an electromagnet with a coil or via electrodes, wherein the intensity of electric current in the coil defines the magnetic field strength or the flux density, whereas the voltage being applied to the electrodes defines the electric field strength, respectively. Due to integration of a permanent magnet into the magnetic circle, which generates the magnetic field for the magnetorheological material, a base force to be transferred can be generated without an electric current in the coil, i.e. without usage of electric energy, by permanently influencing the rheologic properties (i.e. stiffening) of the MR material.

Special embodiments of the device for reducing vibrations according to the invention provide that the magnetorheological material is an magnetorheological fluid (MRF), a magnetorheological gel (MRG), a magnetorheological elastomer (MRE) or a magnetorheological foam (MRFo). A MRG is a material, which in contrast to an MRF is soft, but not fluid. In analogy to an MRF, it can be deformed in any way irreversibly and be stiffened in a magnetic field. An MRE is a chemically cross-linked material, which therefore has a given shape from which it can be deformed reversibly only in limited ways. An MRFo is an elastomeric foam, whose pores are filled with an MRF. In analogy to an MRE, also an MRFo has a defined form, from which it can be deformed reversibly in only limited ways. Likewise to the forgoing, instead of magnetorheological material, also electrorheological material, such as electrorheological fluids (ERF), electrorheological gels (ERG), electrorheological elastomers (ERE) or electrorheological foams (ERFo) can be used.

Possible uses of the device according to the invention are electric controllable devices for reducing vibrations in which a distracting vibration is actively reduced. This is especially interesting for motors or engines with rotating parts, because here, due to the number of revolutions per minute, a special frequency of vibration is defined. The active device for reducing vibrations therefore is to be tuned to this frequency. Examples are engines in automobiles and ships, rotating drums in laundry machines as well as rotating spindles, for example in machine tools, such as milling, drilling or turning machines. Further fields of applications are the reducing of unbalances with rotational movements. Also, the compensation of one-dimensional vibrations resulting from pistons and the like is possible.

In FIG. 1, the principle build-up of the device 1 according to the invention is depicted. Hereby, the device 1 comprises one actively controllable unit 2, which generates a temporarily varying force (F_T), which is connected by force to the force transmitting unit 3. The force transmitting unit 3 herein comprises the unit for generating an electric and/or magnetic field 6, and also a segment 4, which contains an electrorheological and/or magnetorheological material 5. In this embodiment, the bordering elements of the force transmitting unit 3 act as the parts which guide the electric and/or magnetic field to the ER or MR material. The force transmitting unit 3 is connected to the vibrating object 1′ with its side opposite to that which is connected to the device 2. The force generated by the device 2 is transferred to the force transmitting unit 3, which comprises two movable parts, in this special case consisting of the elements of the unit for generating the field 6 and guiding the field to the ER or MR material. By adjustment of the electric and/or magnetic field, the stiffness of the electrorheological and/or magnetorheological material 5 is controlled and thereby also the transmittance of the force (F_T) generated by the device 2 onto the vibrating object 1′. The generated force (F_T) is antipodal to the force (F) generated by the vibration of the vibrating object 1′.

FIG. 2 and FIG. 3 show one special embodiment according to the invention, wherein the device 1 comprises an actively controllable unit 2, which consists of an electric motor 7 and an thereby agitated excenter 8. This excenter 8 is directly fixed to the plate 9, which is movable with respect to the plate 10. Both plates 9 and 10 are comprised within the force transmitting unit 3. Preferably they are made of a magnetic flux guiding material. In this embodiment, the unit for generating a field is an electromagnetic coil 6, which is ring-like and aligned around a segment 4, which contains a magnetorheological material 5. The stiffness of the magnetorheological material 5 and thus the coupling of the force being generated by the device 2 to the plate 10 can be controlled by adjusting the magnetic field strength being generated by the electromagnetic coil 6. The vibrating object 1′ (not shown) can be connected to the plate 10. FIG. 3 shows the device as described in FIG. 2 from top view. Here, it becomes obvious, that the cross-sectional area of the segment 4 containing the magnetorheological material 5 is smaller than the cross-sectional area of the plates 9 and 10. Over more, it is shown that the electromagnetic coil encloses the segment 4 by its ring-like shape.

FIG. 4 shows another special embodiment according to present invention. Again, as already described with FIGS. 2 and 3, the actively controllable unit 2 consists of an electric motor 7 in connection with an excenter 8, which is directly connected to the plate 9. In this special case, the plates 9 and 10 are built of an electrically conductive material. Both plates 9 and 10 serve as electrodes which can be powered by a high voltage supply, which is part of the unit for generating the electric field 6. Both plates 9 and 10 are separated by an electrically insulating material (insulator) 11. Again, as already described with FIGS. 2 and 3, the electrorheological material 5, which is included in the segment 4, can be controlled by the strength of the electric field being applied to the plates 9 and 10. The plates 9 and 10 are movable with respect to each other. The vibrating object 1′ can be connected by force to the plate 10.

1. A device for reducing vibrations of a vibrating object, wherein the device comprises:
a) at least one actively controllable unit for generating a temporarily varying force,
b) at least one force transmitting unit which comprises at least one segment which contains at least one of an electrorheological material and/or a magnetorheological material,
c) at least one unit for generating at least one of an electric field and a magnetic field,
wherein the actively controllable unit is connected by force to the at least one force transmitting unit.

2. The device according to claim 1, wherein the at least one actively controllable unit is at least one device for generating a force that varies in at least one of magnitude and direction.

3. The device according to claim 1 wherein the at least one actively controllable unit is at least one device for generating a force that varies in at least one of one dimension, two dimensions and three dimensions.

4. The device according to claim 1 wherein the at least one actively controllable unit comprises at least one motor.

5. The device according to claim, claim 4 wherein the at least one motor is connected by force to an eccentric for conversion of a circular motion into stroke movement so that the eccentric can be agitated by the motor.

6. The device according to claim 1 wherein the at least one force transmitting unit comprises two elements which are movable with respect to each other, border the force transmitting unit and enclose the at least one segment.

7. The device according to claim 6 wherein the two elements are selected from the group consisting of plates, cuboids, segments, ovoid shaped elements, spherical shells and cones.

8. The device according to claim 7 wherein the elements are movable in at least one of one dimension, two dimensions and three dimensions.

9. The device according to claim 6 wherein one of the elements is connected by force with the at least one actively controllable unit, whereas the other of the elements is connectable by force to the vibrating object.

10. The device according to claim 6 wherein the at least one segment has a cross-sectional area which is dimensioned smaller than the cross-sectional area areas of the elements.

11. The device according to claim 1 wherein the at least one unit for generating at least one of an electric field and a magnetic field is located within the at least one force transmitting unit.

12. The device according to claim 1 wherein the unit for generating at least one of an electric field and a magnetic field is located in the direct proximity to the segment, so that the segment is permeated by the at least one of an electric field and a magnetic field.

13. The device according to claim 1 further comprising at least one of at least one control system for controlling the at least one actively controllable unit and at least one control system for controlling the at least one unit for generating at least one of an electric field and a magnetic field.

14. The device according to claim 1 further comprising at least one sensor for registration of at least one of the amplitude of the vibration of the vibrating object, the frequency of the vibration of the vibrating object and the phase of the vibration of the vibrating object.

15. The device according to claim 13 wherein the at least one control system for controlling the at least one of the at least one actively controllable unit and the at least one control system for controlling the at least one unit for generating at least one of an electric field and a magnetic field is coupled to the at least one sensor for registration of at least one of the amplitude of the vibration of the vibrating object, the frequency of the vibration of the vibrating object and the phase of the vibration of the vibrating object.

16. The device according to claim 1 wherein the at least one unit (6) comprises at least one electromagnetic coil.

17. The device according to the preceding claim, characterized in that the at least one unit for generating at least one of an electric field and a magnetic field further comprises at least one regulable electrical power supply for powering the electromagnetic coil.

18. The device according to claim 16 wherein the at least one electromagnetic coil is located between the elements.

19. The device according to claim 16 wherein the at least one electromagnetic coil is ring-like and aligned concentrically around the at least one segment.

20. The device according to claim 16 wherein the force transmitting unit is part of a magnetic circuit system and comprises at least one ferromagnetic material.

21. The device according to claim 16 wherein the magnetic circuit in the device is at least partially built by a material which has at least one of a relative permeability μᵣ>10 and a saturation magnetization of >0.5 T.

22. The device according to claim 16 wherein the magnetic circuit system comprises at least one permanent magnet.

23. The device according to claim 1 wherein the at least one magnetorheological material is selected from the group consisting of magnetorheological (MR) fluids, MR elastomers, MR thermoplastic elastomers, MR gels and MR foams.

24. The device according to claim 1 wherein the at least one unit for generating at least one of an electric field and a magnetic field comprises two electrodes.

25. The device according to claim 24 wherein the unit for generating at least one of an electric field and a magnetic field further comprises at least one regulable electrical power supply for powering the electrodes.

26. The device according to claim 24 wherein the at least one electrorheological material is selected from the group consisting of electrorheological (ER) fluids, ER elastomers, ER thermoplastic elastomers, ER gels and ER foams.

27. A method for reducing vibrations of a vibrating object, wherein a varying force is generated by at least one actively controllable unit and is transferred to the vibrating object via at least one of an electrorheological material and a magnetorheological material, wherein the varying force is adjusted by modulation of the at least one of an electrorheological material and a magnetorheological material so that the varying force counteracts at least partially the force resulting from the vibration of the vibrating object.

28. The method according to claim 27 wherein the force being generated by the at least one actively controllable unit is varied in at least one of its magnitude and its direction in transmission to the vibrating object.

29. The method according to claim 27 wherein the force being generated by the at least one actively controllable unit is varied in at least one of one dimension, two dimensions and three dimensions.

30. The method according to claim 27 wherein the at least one actively controllable unit generates the force with a frequency which at least temporarily matches the frequency of the vibration of the vibrating object.

31. The method according to claim 27 wherein the at least one actively controllable unit generates the force with a phase that at least one of at least temporarily is antipodal to the phase of the vibration of the vibrating object and at least partially is antipodal to the phase of the vibration of the vibrating object.

32. The method according to claim 27 wherein at least two actively controllable units generate the varying force.

33. The method according to claim 32 wherein each of the at least two actively controllable units generates varying forces which are superimposed thus resulting in the varying force which is transferred to the vibrating object.

34. The method according to claim 27 wherein the varying force being generated by the at least one actively controllable unit results from at least one of the rotation of an eccentric and/or the agitation of a motor.

35. The method according to claim 34 wherein the eccentric is actuated by a motor.

36. The method according to claim 35 wherein the speed of the motor is controlled as a function of the frequency of the vibration of the vibrating object so that the frequency of the unbalance generated by the rotation of the eccentric at least temporarily matches the frequency of the vibration of the vibrating object.

37. The method according to claim 35 wherein the motor is controlled so that the phase of the unbalance generated by the rotation of the eccentric at least one of at least temporarily is antipodal to the phase of the vibration of the vibrating object and at least partially is antipodal to the phase of the vibration of the vibrating object.

38. The method according to claim 35 wherein the magnitude of the resulting varying force at least temporarily is adjusted at least to the same magnitude as the magnitude of the force resulting from the vibration of the vibrating object.

39. The method according to claim 38 wherein the adjusting of the magnitude of the force is achieved by modulation of at least one rheological property of the at least one of a electrorheological material and a magnetorheological material.

40. The method according to claim 39 wherein the at least one rheological property is controlled by application of at least one of an electric field and a magnetic field.

41. The method according to claim 40 wherein the field intensity of the at least one of an electric field and a magnetic field is at least one of held constant, varied and a constant field is superposed with a varying field.

42-44. (canceled)

45. A method for reducing vibrations of a vibrating object comprising generating a varying force with at least one actively controllable unit and transferring the varying force to the vibrating object via at least one of an electrorheological material and a magnetorheological material, and adjusting the varying force by modulation of the at least one of an electrorheological material and a magnetorheological material so that the varying force counteracts at least partially the force resulting from the vibration of the vibrating object, the method comprising providing a device comprising at least one actively controllable unit for generating a temporarily varying force, providing at least one force transmitting unit which comprises at least one segment which contains at least one of an electrorheological material and a magnetorheological material, providing at least one unit for generating at least one of an electric field and a magnetic field, and connecting the actively controllable unit by force to the at least one force transmitting unit.

46. A method for at least one of reducing vibrations and damping unbalances comprising providing a device comprising at least one actively controllable unit for generating a temporarily varying force, providing at least one force transmitting unit which comprises at least one segment which contains at least one of an electrorheological material and a magnetorheological material, providing at least one unit for generating at least one of an electric field and a magnetic field, and connecting the actively controllable unit by force to the at least one force transmitting unit.

47. A method for at least one of reducing vibrations, damping at least one of unbalances and unbalanced masses, and compensation of at least one of unbalances and unbalanced masses comprising generating a varying force with at least one actively controllable unit and transferring the varying force to the vibrating object via at least one of an electrorheological material and a magnetorheological material, and adjusting the varying force by modulation of the at least one of an electrorheological material and a magnetorheological material so that the varying force counteracts at least partially the force resulting from the vibration of the vibrating object.
